(19) United States
(12) Patent Application Publication
(10) Pub. No.: US 2026/0027739 A1
(43) Pub. Date: Jan. 29, 2026

(54) RAZOR ASSEMBLY

(71) Applicant: DORCO CO., LTD., Seoul (KR)

(72) Inventors: Ji Hun KI, Seoul (KR); Da Woon HAN, Seoul (KR); Sang Hun PARK, Seoul (KR)

(21) Appl. No.: 19/342,174

(22) Filed: Sep. 26, 2025

Related U.S. Application Data
(63) Continuation of application No. PCT/KR2024/003969, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22; B26B 21/40

(52) U.S. Cl. CPC B26B 21/521; B26B 21/225; B26B 21/4012

(57) ABSTRACT

A razor assembly includes a razor cartridge, which is provided with a connector, and a razor handle, which detachably couples to the connector to rotatably support the razor cartridge. The razor handle may include a first arm and a second arm, which are spaced apart in the longitudinal direction, move away from each other to couple to the connector, and move towards each other to detach from the connector. The razor handle may also include a handle head, which accommodates at least parts of the first and second arms. The razor cartridge may include a pair of guide posts including inner support surfaces formed so as to face the outer sides of the handle head in the state in which the razor cartridge and the razor handle are coupled to each other.

### CROSS REFERENCE TO RELATED APPLICATIONS

This is a continuation application of International Patent Application No. PCT/KR2024/003969 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The disclosure relates to a razor assembly, and more specifically to a razor assembly including a razor cartridge and a razor handle.

### Description of Related Technology

In general, a razor refers to a product for cutting body hair such as fuzz and beard on a face or body, and includes a razor handle for gripping, and a razor cartridge with a razor blade that comes into contact with skin to shave.

### SUMMARY

One aspect is a razor assembly, in which a razor handle and a razor cartridge are easily and accurately coupled, and a user can easily recognize a coupling direction of the razor handle to the razor cartridge.

Another aspect is a razor assembly, in which a coupling state between a razor handle and a razor cartridge can be maintained even though an excessive external force or impact force is applied to the razor cartridge while the razor handle and the razor cartridge are coupled.

The aspects of the disclosure are not limited to those described herein, and other aspects not mentioned herein may become apparent to those skilled in the art from the following description.

Another aspect is a razor assembly that includes a razor cartridge provided with a connector, and a razor handle detachably coupled to the connector and pivotably supporting the razor cartridge, wherein the razor handle includes a first arm and a second arm, the first and second arms which are spaced apart from each other in a longitudinal direction, coupled to the connector by moving away from each other, and detached from the connector by moving closer to each other; and a handle head configured to receive at least a portion of the first arm and the second arm, and the razor cartridge includes a pair of guide posts having inner supporting surfaces formed to face outer lateral surfaces of the handle head while the razor cartridge and the razor handle are coupled.

Other details of the disclosure are included in the detailed description and the accompanying drawings.

According to the embodiments of the disclosure, the effects are at least as follows.

The coupling portion provided in the razor handle and coupled to the connector of the razor cartridge is not exposed to the outside.

Therefore, the coupling portion is protected from external impact, thereby extending the lifespan of the razor handle.

Further, the razor handle and the razor cartridge are easily and accurately coupled.

In addition, a user can easily recognize the coupling direction of the razor handle to the razor cartridge.

In addition, the coupling state between the razor handle and the razor cartridge is maintained even though an external force or impact force is excessively applied to the razor cartridge.

The effects of the disclosure are not limited to those described above, and various other effects are included in the foregoing description.

### BRIEF DESCRIPTION OF THE DRAWINGS

FIG. 1 is a perspective view of a razor assembly according to an embodiment of the disclosure.

FIG. 2 is a plane view of a razor cartridge according to an embodiment of the disclosure.

FIG. 3 is a bottom view of a razor cartridge according to an embodiment of the disclosure.

FIG. 4 is a perspective view showing the bottom of a razor cartridge according to an embodiment of the disclosure.

FIG. 5 is an exploded perspective view of a handle head according to an embodiment of the disclosure, viewed from above.

FIG. 6 is an exploded perspective view of a handle head according to an embodiment of the disclosure, viewed from below.

FIG. 7 is a view showing a position relationship among a first arm, a second arm and a pusher in a neutral state.

FIG. 8 is a view showing a position relationship among a first arm, a second arm and a pusher in a coupling process.

FIG. 9 is a view showing a position relationship among a first arm, a second arm and a pusher in a detachment process.

FIG. 10 is a plan view showing a state immediately before a handle head is coupled to a razor cartridge according to an embodiment of the disclosure.

FIG. 11 is a bottom view showing the handle head in the state of FIG. 10.

FIG. 12 is a plan view showing a state that a handle head is coupled to a razor cartridge according to an embodiment of the disclosure.

FIG. 13 is a bottom view showing the handle head in the state of FIG. 12.

FIG. 14 is a perspective view showing a portion of a razor assembly from which the plunger is omitted from the state of FIG. 12.

FIG. 15 is a cross-sectional view illustrating a state that a pivot angle of a razor cartridge according to an embodiment of the disclosure is restricted by a first end portion, a second end portion, and an inner wall of a connecting hole.

FIG. 16 is an enlarged view of an area A shown in FIG. 15.

FIG. 17 is a cross-sectional view illustrating a state that a pivot angle of a razor cartridge according to an embodiment of the disclosure is restricted by a plunger.

FIG. 18 is a bottom view illustrating a state that a pivot angle of a razor cartridge according to an embodiment of the disclosure is restricted by a stepped portion.

FIG. 19 is a cross-sectional view taken along line X IX-X IX′ of FIG. 18.

FIG. 20 is a view illustrating a state that a plunger housing according to an embodiment of the disclosure is supported by a head supporting portion.

FIG. 21 is a bottom view illustrating a state that the plunger housing rotating clockwise or counterclockwise is supported by the head supporting portion of FIG. 20.

### DETAILED DESCRIPTION

To make the razor cartridge come into close contact with a user's skin along the curvy contours of the skin, the razor cartridge is pivotally coupled to the razor handle.

The razor handle is formed with a coupling portion for coupling with the razor cartridge, and the coupling portion generally has a structure in which the razor cartridge is pivotally coupled to the razor handle.

In the process of coupling the razor handle and the razor cartridge, the coupling portion and the razor cartridge are often improperly coupled, or it is often inconvenient for a user to couple the razor handle and the razor cartridge due to poor recognition of a coupling direction of the coupling portion with respect to the razor cartridge.

In addition, when an external force or impact force exceeding the force required to pivot the razor cartridge to the maximum pivot angle is applied to the razor cartridge while the razor handle and the razor cartridge are coupled, the razor cartridge and the razor handle are often become detached without maintaining the coupling state between the razor handle and the razor cartridge.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, in describing components according to an embodiment of the disclosure, terms such as first, second, i), ii), a), and b) may be used. These terms are merely for distinguishing one component from other components, but not limit the substances, order, or sequence of the components. Throughout this specification, when a part “includes” or “comprises” a component, this means that the part further includes other components rather than excluding other components unless explicitly stated otherwise.

Below, a razor assembly according to embodiments of the disclosure will be described with reference to the accompanying drawings.

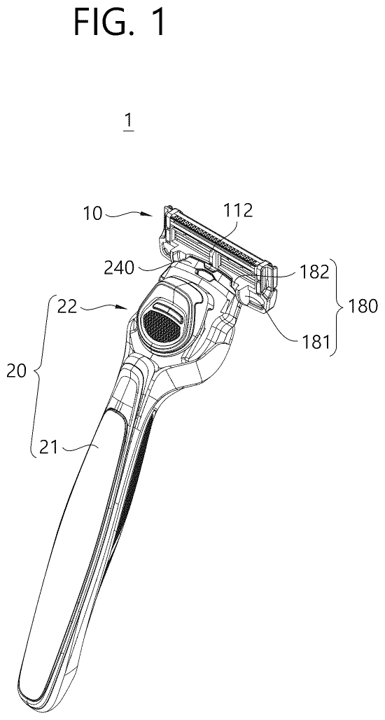

FIG. 1 is a perspective view of a razor assembly 1 according to an embodiment of the disclosure.

Referring to FIG. 1, the razor assembly 1 according to an embodiment includes a razor cartridge 10, and a razor handle 20 to which the razor cartridge 10 is pivotally coupled.

The razor handle 20 includes a handle body 21 and a handle head 22.

The handle body 21 refers to a portion to be gripped by a user.

The handle head 22 is provided at a first end of the handle body 21, is detachably coupled to the razor cartridge 10, and pivotally supports the coupled razor cartridge 10.

The handle head 22 may be detachably coupled to a connector 180 formed in the razor cartridge 10, and pivotably support the razor cartridge 10 within a predetermined angular range about a fixed axis or an axis moving within a predetermined range. For example, the razor cartridge 10 may be pivotably supported within an angular range less than or equal to 90 degrees, preferably less than or equal to 50 degrees, more preferably less than or equal to 45 degrees from a resting position (i.e., a position where the razor cartridge 10 receives no external force while being coupled to the razor handle 20) with respect to the razor handle 20. Regarding the handle head 22, details will be described later.

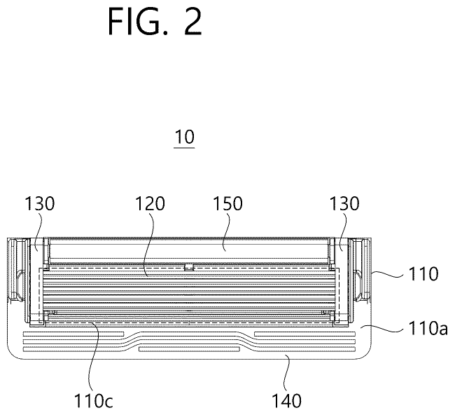

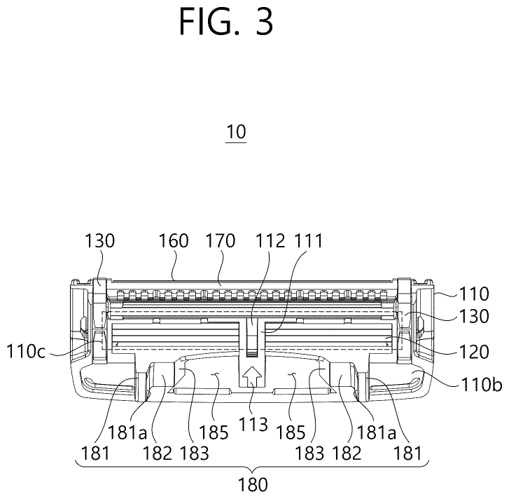

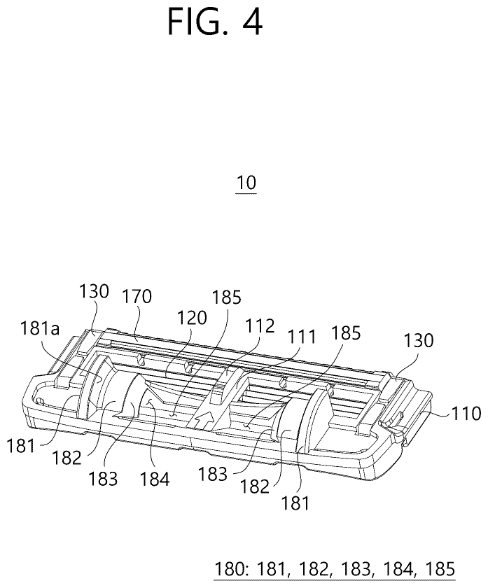

FIG. 2 is a plane view of the razor cartridge 10 according to an embodiment of the disclosure, FIG. 3 is a bottom view of the razor cartridge 10 according to an embodiment of the disclosure, and FIG. 4 is a perspective view showing the bottom of the razor cartridge 10 according to an embodiment of the disclosure.

Referring to FIG. 2, the razor cartridge 10 may include all or some of a blade housing 110, a plurality of blades 120, a clip 130, a guard 140, and a cap 150.

The blade housing 110 may receive the blades 120 in a longitudinal direction, and include an upper surface 110a exposing cutting edges, a lower surface 110b (see FIG. 3) facing the upper surface 110a, and a rinsing opening 110c. The blades 120 may be arranged in a row in a transverse direction. With reference to FIG. 2, the longitudinal direction refers to a horizontal direction, and the transverse direction refers to a vertical direction. FIG. 2 illustrates an example that the razor cartridge 10 includes five blades 120, but the number of blades 120 may vary depending on embodiments. The upper surface 110a of the blade housing 110 described below refers to a surface that comes into contact with or faces a user's skin during a shaving process, which may be a surface toward which the cutting edge of each blade 120 faces. FIG. 2 illustrates the upper surface 110a of the blade housing 110.

Further, the lower surface 110b of the blade housing 110 refers to a surface located on the opposite side of the upper surface 110a. FIG. 3 illustrates the lower surface 110b of the blade housing 110.

Further, the rinsing opening 110c is formed penetrating the blade housing 110 from the upper surface 110a to the lower surface 110b, and allows the blades 120 to be longitudinally arranged thereacross. Through the rinsing opening 110c, shaving residues, such as shaving cream and cut body hair, may be discharged.

Further, the front of the blade housing 110 may be a direction (shaving direction) in which the blade housing 110 moves relative to a user's skin during the shaving process. For example, with reference to FIG. 2, the front of the blade housing 110 may refer to a direction from the blade 120 toward the guard 140.

Further, the rear of the blade housing 110 may be a direction opposite to the foregoing front, and, with respect to FIG. 2, the rear of the blade housing 110 may refer to a direction from the blade 120 toward the cap 150.

The clip 130 refers to a component to prevent the plurality of blades 120 from being disengaged with the blade housing 110, and may be coupled to the blade housing 110 in various ways according to embodiments. Further, instead of the clip 130, an additional (e.g., a cover member coupled to the upper surface 110a of the blade housing 110) may be used to prevent the detachment of the plurality of blades 120 from the blade housing 110.

The guard 140 may be provided at the front of the upper surface 110a of the blade housing 110.

The guard 140 comes into close contact with a user's skin during the shaving process and pulls the skin to enhance a shaving effect of the blade 120. To pull the user's skin more effectively, the guard 140 may include an embossed or engraved pattern on the upper surface thereof, and the upper surface of the guard 140 may be formed of a material such as rubber or silicone.

The cap 150 may be provided at the rear of the upper surface 110a of the blade housing 110.

The cap 150 may include a lubricating band exposed to the upper surface 110a of the blade housing 110. The lubricating band includes a lubricating material and applies the lubricating material to a skin surface that the blade 120 has passed over during the shaving process. The lubricating material may include ingredients for protecting the skin after shaving.

Referring to FIGS. 3 and 4, the blade housing 110 may include a cam support portion 111 on the lower surface 110b thereof, and a cam 112 protruding from the cam support portion 111. In the state that the razor cartridge 10 and the razor handle 20 are coupled, the cam 112 may be in contact with a plunger 240 (to be described later) to restrict a pivot motion of the razor cartridge 10. The cam support portion 111 may be provided at a central portion on the lower surface 110b of the blade housing 110 and support a base portion of the plurality of blades 120. The cam support portion 111 may be formed with a mark 113 (e.g., an arrow mark) for indicating a coupling direction of the handle head 22 of the razor handle 20.

The razor cartridge 10 may include a connector 180. The connector 180 refers to a component to detachably couple with the handle head 22 of the razor handle 20. The connector 180 may be coupled to the blade housing 110 or formed integrally with the blade housing 110 on the lower surface 110b of the blade housing 110. Alternatively, the connector 180 may be provided in a fixed configuration in the blade housing 110.

The connector 180 may be positioned not to overlap with the blades 120 so that shaving residues (e.g., shaving cream, cut hair, etc.) can be effectively discharged along with washing water through a space between the plurality of blades 120.

The connector 180 may include a pair of guide posts 181, a pair of stepped portions 182, a connecting groove 185, a pair of guide surfaces 183 and a pair of connecting holes 184.

The pair of guide posts 181 may be formed to protrude from the blade housing 110 while being longitudinally spaced apart from each other so as not to overlap the rinsing opening 110c. The pair of guide posts 181 may be formed to protrude from the pair of stepped portions 182 toward the outer lateral surfaces of plunger housings 230 and 270 (to be described later). A space between the pair of guide posts 181 forms a space into which the plunger 240 of the razor handle 20 (to be described later) enters.

Each of the guide posts 181 may include the inner supporting surface 181a. To ensure smooth entry of the plunger 240 and plunger housing 230 and 270, the inner supporting surface 181a may form an inclined surface so that the space between the pair of guide posts 181 can gradually become narrower toward the cam 112.

Referring to FIG. 3, the inner supporting surface 181a may face the outer lateral surface of the handle head 22 while the razor cartridge 10 and the razor handle 20 are coupled. The outer lateral surface of the handle head 22 that the inner supporting surface 181a faces may be the outer lateral surface of the plunger housings 230 and 270 (to be described later). The inner supporting surface 181a may support the outer lateral surface of the plunger housings 230 and 270 to limit the longitudinal movement of the razor cartridge 10. Because the inner supporting surface 181a is adjacent to both lateral sides the handle head with respect to the longitudinal direction, a first arm 291 and a second arm 292 (to be described later) may be prevented from being detached from the connector 180 by the longitudinal movement of the razor cartridge 10, or the razor cartridge 10 may be prevented from being excessively shaken from the razor handle 20 due to a gap in a coupling area between the razor cartridge 10 and the razor handle 20.

The pair of stepped portions 182 may be formed to protrude from the blade housing 110 while being longitudinally spaced apart from each other between the pair of guide posts 181 so as not to overlap the rinsing opening 110c. The stepped portions 182 may extend from the pair of guide posts 181 so as to face the handle head 22. The handle head 22 that the stepped portions 182 face may be an open distal end portion of the plunger housings 230 and 270 (to be described below).

The stepped portions 182 may form a height difference from the guide post 181 so that the guide post 181 protrudes further from the blade housing 110 than the stepped portions 182. In the state that the razor cartridge 10 and the razor handle 20 are coupled, the stepped portions 182 may be adjacent to the plunger 240 (to be described later) or may support the plunger 240.

Referring to FIGS. 3 and 4, the connecting groove 185 may be formed between the pair of stepped portions 182. The connecting groove 185 refers to a space that a first end portion 291c of the first arm 291 and the second end portion 292c of the second arm 292 (to be described later) enter.

Referring to FIGS. 3 and 4, the pair of guide surfaces 183 form inclined surfaces from the stepped portions 182, respectively, so that the gap between the pair of guide surfaces 183 can become narrower gradually toward the cam 112. The pair of guide surfaces 183 guides the first end portion 291c and the second end portion 292c of the connecting portion 290 (to be described later) to come closer toward each other when they enter between the pair of guide surfaces 183.

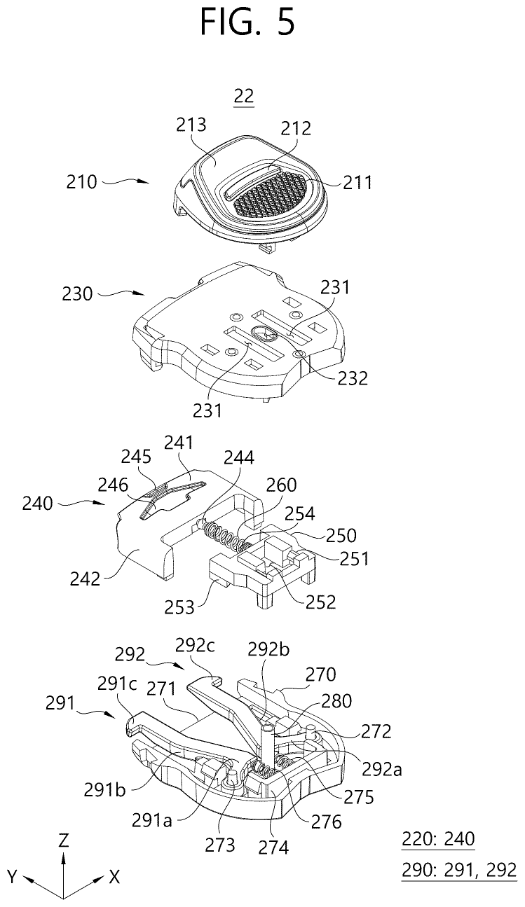

The pair of connecting holes 184 may be formed between each guide surface 183 and the blade housing 110. The connecting hole 184 may receive therein the first end portion 291c (see FIG. 5) and the second end portion 292c (see FIG. 5) of the connecting portion 290 (to be described later). The connecting hole 184 may be shaped like a fan when viewed from one side in the longitudinal direction, but is not necessarily limited thereto.

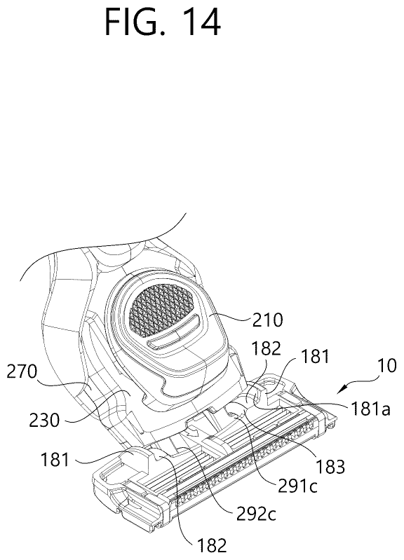

The first end portion 291c and the second end portion 292c move away from each other again when passed the pair of guide surfaces 183 and enter the connecting hole 184 to complete the connection between the razor cartridge 10 and the razor handle 20 (see FIG. 14).

The pair of connecting holes 184 may receive the first end portion 291c and the second end portion 292c therein to form a pivot axis of the razor cartridge 10 with respect to the razor handle 20. According to this embodiment, the pair of connecting holes 184 are adjacent to the upper surface 110a of the blade housing 110, the pivot axis of the razor cartridge 10 is formed close to a shaving plane on which shaving is actually performed, thereby enabling close shaving.

Meanwhile, the blade housing 110 may include at least one rib (not shown) extending from the lower surface 110b and substantially parallel to the cam supporting portion 111. Specifically, a pair of ribs may be provided, and each of the ribs may be arranged being longitudinally spaced apart from each other on both sides of the cam supporting portion 111. The ribs may prevent the first end portion 291c and the second end portion 292c from being incorrectly inserted in the lower surface 110b and damaging the blades 120. Further, when the razor cartridge 10 excessively pivots about the razor handle 20, both lateral end portions of the plunger 240 may come into contact with the ribs to alleviate impact applied to the razor cartridge 10, e.g., the cam 112.

Regarding the coupling, detachment, etc. between the connector 180 and the coupling portion 290, more detailed descriptions will be made later.

The razor cartridge 10 may additionally include a trimming blade 160 and a trimming guard 170.

The trimming blade 160 is received between the trimming guard 170 and the blade housing 110 so that the cutting edge thereof can be exposed toward the rear of the razor cartridge 10. The trimming blade 160 may be used to cut hair in a relatively narrow region, such as sideburns, a mustache, etc. The trimming guard 170 may be formed with a plurality of combs arranged side by side in the longitudinal direction to align the hair before being cut by the trimming blade 160.

Below, the handle head 22 of the razor handle 20 will be described.

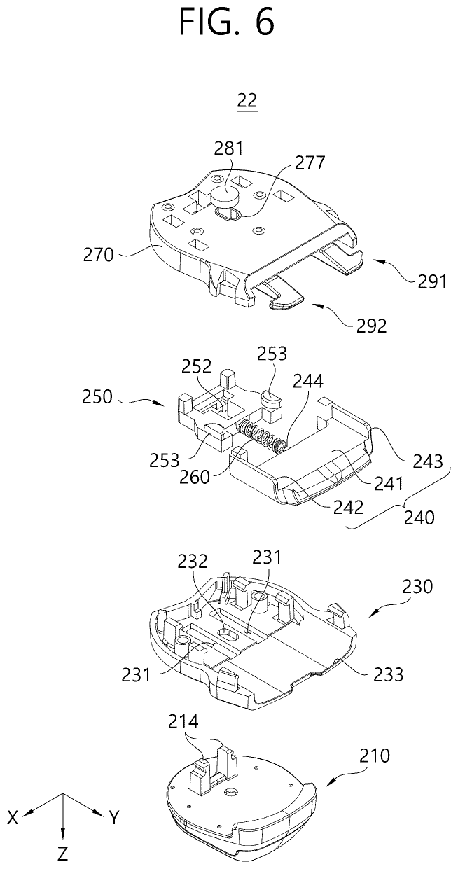

FIG. 5 is an exploded perspective view of the handle head 22 according to an embodiment of the disclosure, viewed from above, and FIG. 6 is an exploded perspective view of the handle head 22 according to an embodiment of the disclosure, viewed from below.

Referring to FIGS. 5 and 6, the handle head 22 according to an embodiment of the disclosure may include an operating portion 210, a restoring force providing portion 220, and the coupling portion 290.

The operating portion 210 is configured to operate the coupling portion 290 by moving a pusher 250, which will be described later. A user may operate the operating portion 210 in the state that the razor cartridge 10 and the razor handle 20 are coupled, thereby detaching the razor cartridge 10 and the razor handle 20. In this regard, details will be described later.

Referring to FIG. 5, the operating portion 210 is located in the upper portion of the handle head 22 (see FIG. 1), and has an upper surface formed with, but not limited to, a friction surface 211 for increasing friction with a user's finger, a stepped portion 212 for preventing the user's finger from slipping, and an upward inclined surface 213 for supporting the user's finger. The friction surface 211, the stepped portion 212 and the inclined surface 213 allow a user to more easily move the operating portion 210 when s/he pushes the operating portion 210 with a finger (or a thumb) in a first direction. Here, the first direction may refer to a direction from the handle head 22 toward the razor cartridge 10. Referring to FIGS. 5 and 6, the first direction is a positive Y-axis direction. An X-axis refers to a longitudinal direction perpendicular to the Y-axis on a horizontal plane, a positive Z-axis direction refers to an upward direction, and a negative Z-axis direction refers to a downward direction.

Referring to FIG. 6, the operating portion 210 has a lower surface provided with a pusher coupling portion 214 extending downwards (in the negative Z-axis direction). The pusher coupling portion 214 couples with the pusher 250 penetrating a plunger upper housing 230 (to be described later) and received in the plunger housings 230 and 270. Accordingly, the pusher 250 received in the plunger housings 230 and 270 moves integrally with the operating portion 210 located outside the plunger housings 230 and 270.

The restoring force providing portion 220 is configured to provide a restoring force to the razor cartridge 10, which is pivotable about the razor handle 20 within a certain angular range. Referring to FIGS. 5 and 6, the handle head 22 according to an embodiment of the disclosure includes the plunger 240 as the restoring force providing portion 220, but is not limited thereto, and the restoring force providing portion 220 may include a cantilever structure and/or a rubber member having an elastic force to provide the restoring force to the razor cartridge 10. Hereinafter, for convenience of description, an example that the restoring force providing portion 220 includes the plunger 240 will be described.

The plunger housings 230 and 270 include the plunger upper housing 230 and a plunger lower housing 270. The plunger upper housing 230 and the plunger lower housing 270 form a space in which the plunger 240, the pusher 250 and the coupling portion 290 are received. The plunger upper housing 230 and the plunger lower housing 270 may receive at least a portion of the plunger 240 and the connecting portion 290, and may receive the whole of the pusher 250.

Referring to FIG. 5, the plunger upper housing 230 may have a pusher coupling slot 231 and a first pin through slot 232 formed therethrough. The pusher coupling slot 231 and the first pin through slot 232 may be formed long along the first direction.

The pusher coupling portion 214 of the operating portion 210 passes through the pusher coupling slot 231, and the first end of a pin 280 passes through the first pin through slot 232 and is coupled to the operating portion 210. The pusher coupling portion 214 is movable in the first direction along the pusher coupling slot 231. Accordingly, the operating portion 210 is movable in the first direction with respect to the plunger upper housing 230.

Referring to FIG. 6, a distal end portion 233 of the plunger upper housing 230 may be open in the first direction such that the plunger 240 and the coupling portion 290 are at least partially exposed or appear or disappear from the plunger upper housing 230.

Referring back to FIG. 5, a distal end portion 271 of the plunger lower housing 270 may also be open in the first direction such that the plunger 240 and the coupling portion 290 are at least partially exposed or appear or disappear from the plunger lower housing 270.

The plunger lower housing 270 may be internally formed with a first arm rotation pin 273 and a second arm rotation pin 272, on which a first arm 291 and a second arm 292 of the coupling portion 290 are rotatably installed.

Further, the plunger lower housing 270 may be internally formed with a support base 274 to determine a retreat limit of the pusher 250 in the first direction. The support base 274 may be provided between the first arm rotation pin 273 and the second arm rotation pin 272, without restricting the intended rotation of the first arm 291 and the second arm 292. Further, the first arm 291 may be elastically supported by an elastic member 276 provided between the support base 274 and the first arm 291, and the second arm 292 may be elastically supported by an elastic member 275 provided between the support base 274 and the second arm 292. In other words, the first arm 291 and the second arm 292 may be elastically supported by the support base 274. The first arm 291 and the second arm 292 may be elastically supported in a direction in which the elastic members 275 and 276 is stretched, respectively. In other words, the elastic members 275 and 276 may provide a restoring force in a direction in which the first end portion 291c and the second end portion 292c exposed to the outside of the plunger housings 230 and 270 move away from each other.

Referring to FIGS. 5 and 6, the plunger lower housing 270 may have the second pin through slot 277 formed therethrough. The second pin through slot 277 may be formed long along the first direction.

The second end of the pin 280 may be exposed to the lower portion of the plunger lower housing 270 (in the negative Z-axis direction) through the second pin through slot 277, and the second end of the pin 280 is provided with a flange 281 having a diameter larger than the width of the second pin through slot 277 to prevent the second end of the pin 280 from entering the plunger housings 230 and 270.

When the operating portion 210 moves, the shaft 280 moves together with the operating portion 210 in the first direction along the first shaft through slot 232 and the second shaft through slot 277, and thus the moving direction of the operating portion 210 is limited to the direction parallel to the first direction.

Referring to FIG. 5, the pusher 250 may include an operating-portion coupling portion 251 coupled to the pusher coupling portion 214 of the operating portion 210. FIGS. 5 and 6 illustrate an example that the pusher coupling portion 214 and the operating-portion coupling portion 251 have a hook-coupled structure, but the pusher coupling portion 214 and the operating-portion coupling portion 251 may be modified to have various coupling structures.

Further, the pusher 250 may be formed with a third pin through slot 252 through which the central portion of the pin 280 passes.

Referring to FIG. 5 and FIG. 6, a pair of driving protrusions 253 spaced apart in the longitudinal direction are formed on the lower surface of the pusher 250. The pair of driving protrusions 253 are positioned to be in contact with a first driving surface 291b of the first arm 291 and a second driving surface 292b of the second arm 292, respectively. As the pusher 250 moves forward/backward, the driving protrusion 253 interacts with the first driving surface 291b and the second driving surface 292b so that the first arm 291 can rotate around the first arm rotation pin 273, and the second arm 292 can rotate around the second arm rotation pin 272. In this regard, detailed descriptions will be made later.

The pusher 250 may be formed with a first elastic member mounting portion 254 at a distal end portion thereof, on which the first end of an elastic member 260 for elastically supporting the pusher 250 and the plunger 240 is installed.

Referring to FIGS. 5 and 6, the plunger 240 may include an upper cover 241, a first lateral wall 243 extending downwardly from the first side of the upper cover 241 and a second lateral wall 242 extending downwardly from the second side of the upper cover 241.

The plunger 240 may be provided to slide and move along the first direction within the plunger housings 230 and 270. The plunger 240 may slide in conjunction with the pivot of the razor cartridge 10 and provide a restoring force to the razor cartridge 10.

In the state that the plunger 240 is elastically supported by the elastic member 260 and is positioned at a forward limit point in the first direction, the upper cover 241 may be positioned to cover all or a portion of the first end portion 291c of the first arm 291 and the second end portion 292c of the second arm 292.

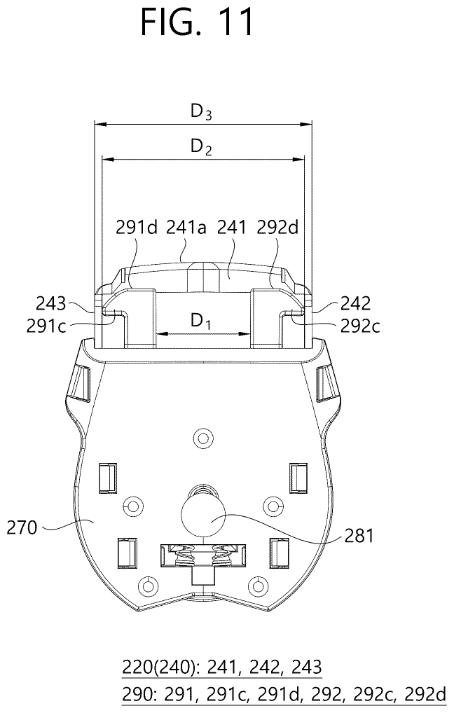

As the razor cartridge 10 pivots from a rest position, the plunger 240 may retreat rearward. In this case, the retreating direction of the plunger 240 refers to a direction from the distal end portion 241a (see FIG. 11) of the plunger 240 toward the plunger housings 230 and 270. In the state that the elastic member 260 elastically supporting the plunger 240 is compressed and the plunger 240 is positioned at a retreat limit point in the first direction, the upper cover 241 may be positioned to expose the first end portion 291c of the first arm 291 and the second end portion 292c of the second arm 292 to the outside.

The upper cover 241 may include a cam contact portion 245 formed at a distal end portion thereof and comes into contact with the cam 112 of the razor cartridge 10. The cam contact portion 245 may be shaped to define the pivot motion of the razor cartridge 10 relative to the razor handle 20 by interacting with the shape of the cam 112. The cam contact portion 245 may be engraved and/or embossed relative to the upper cover 241.

The upper cover 241 may include a mark 246 (e.g., an arrow mark) formed to indicate the coupling direction of the handle head 22 to the razor cartridge 10. The mark 246 allows a user to easily recognize the coupling direction of the razor handle 20 to the razor cartridge 10. The mark 246 may be formed at a position to be aligned with the mark 113 formed in the razor cartridge 10 during the coupling process between the razor cartridge 10 and the razor handle 20 in the coupling direction, thereby allowing a user to more clearly recognize the coupling direction of the razor handle 20 to the razor cartridge 10.

The plunger 240 may include a second elastic member mounting portion 244 formed at the rear end thereof, on which the second end of the elastic member 260 for elastically supporting the pusher 250 and the plunger 240 is installed.

Referring to FIG. 5, the coupling portion 290 may include the first arm 291 and the second arm 292 which are spaced from each other in the longitudinal direction. The first arm 291 and the second arm 292 may be installed inside the connecting hole 184 of the connector 180 and may be detached from the connector 180 while approaching each other.

In the embodiment shown in FIG. 5, the coupling portion 290 includes the first arm 291 and the second arm 292, but the disclosure is not limited thereto. The coupling portion 290 may employ various configurations to detachably couple with the razor cartridge 10. For example, besides the pair of arms 291 and 292, the coupling portion 290 may use a latch coupling method, a hook coupling method, a snap-fit coupling method, a boss coupling method, a magnetic-based coupling method, etc. to detachably couple with the razor cartridge 10. However, for convenience of description, the following description will be made based on an example that the coupling portion 290 includes the first arm 291 and the second arm 292.

Further, as described above, the restoring force providing portion 220 may be included in the razor handle 20, but the disclosure is not limited thereto. According to an embodiment, the restoring force providing portion 220 may be included in the razor cartridge 10.

In this case, the restoring force providing portion 220 may be positioned on the connector 180, and the connector 180 may be pivotably connected to the blade housing 110. Further, as described above, the restoring force providing portion 220 may include a cantilever structure and/or a rubber member providing an elastic force besides the elastically supported plunger 240, thereby providing the restoring force to the razor cartridge 10. When the restoring force providing portion 220 is provided in the razor cartridge 10, the restoring force providing portion 220 may cover at least a part of the coupling portion 290 in the process of coupling or detaching the razor cartridge 10 and the razor handle 20. In the state that the razor cartridge 10 and the razor handle 20 are coupled, the restoring force providing portion 220 may cover at least a part of the coupling portion 290.

The first arm 291 may include a first driving arm 291a, the first driving surface 291b, and the first end portion 291c.

The first driving arm 291a has a first side rotatably installed on the first arm rotation pin 273. The first driving arm 291a extends toward the open distal end portions of the plunger housings 230 and 270.

The first driving surface 291b may form at least a portion of an outer surface of the first driving arm 291a, and may be formed to form an outward slope in the first direction, but is not necessarily limited thereto.

The first end portion 291c is formed on a second side of the first driving arm 291a, which is exposed to the outside of the plunger housings 230 and 270. The first end portion 291c may be formed to protrude outwardly from the first driving arm 291a. The front side of the first end portion 291c may be formed to be inclined toward the negative X-axis direction, and the rear side of the first end portion 291c may form the stepped portion approximately perpendicular to the first driving arm 291a, but is not necessarily limited thereto. For example, when the first end portion 291c is detachably coupled to the razor cartridge 10 by a shell-bearing coupling method, the first end portion 291c may include a shell-bearing.

In the case where the front side of the first end portion 291c is formed to be inclined toward the negative X-axis direction, when the razor cartridge 10 and the razor handle 20 are coupled, the first end portion 291c smoothly moves along the guide post 181, the stepped portion 182 and the guide surface 183 of the connector 180, and the first driving arm 291a naturally rotates around the first arm rotation pin 273, thereby inducing natural coupling between the razor cartridge 10 and the razor handle 20. However, the front side shape of the first end portion 291c may be varied depending on the structure, etc. of the connector 180, and may be configured without the inclined surface toward the negative X-axis direction.

When the first end portion 291c includes the stepped portion formed on the rear side thereof, which is approximately perpendicular to the first driving arm 291a, the first end portion 291c is prevented from being disengaged in the negative Y-axis direction while being inserted in the connecting hole 184, so that the razor cartridge 10 and the razor handle 20 can be maintained in the coupled state. The rear side of the first end portion 291c may be modified to have various shapes so as not to form the stepped portion that is approximately perpendicular to the first driving arm 291a, and to prevent the first end portion 291c from being disengaged in the negative Y-axis direction while the first end portion 291c is inserted in the connecting hole 184.

The second arm 292 may include a second driving arm 292a, the second driving surface 292b, and the second end portion 292c.

The second driving arm 292a has a first side rotatably installed on the second arm rotation pin 272. The second driving arm 292a extends toward the open distal end portions of the plunger housings 230 and 270.

The second driving surface 292b may form at least a portion of an outer surface of the second driving arm 292a, and may be formed to form an outward slope in the first direction, but is not necessarily limited thereto.

The second end portion 292c is formed on a second side of the second driving arm 292a, which is exposed to the outside of the plunger housings 230 and 270. The second end portion 292c may be formed to protrude outwardly from the second driving arm 292a. The front side of the second end portion 292c may be formed to be inclined rearwards, and the rear side of the second end portion 292c may form the stepped portion approximately perpendicular to the second driving arm 292a, but is not necessarily limited thereto. For example, when the second end portion 292c is detachably coupled to the razor cartridge 10 by a shell-bearing coupling method, the second end portion 292c may include a shell-bearing.

In the case where the front side of the second end portion 292c is formed to be inclined toward the positive X-axis direction, when the razor cartridge 10 and the razor handle 20 are coupled, the second end portion 292c smoothly moves along the guide post 181, the stepped portion 182 and the guide surface 183 of the connector 180, and the second driving arm 292a naturally rotates around the second arm rotation pin 272, thereby inducing natural coupling between the razor cartridge 10 and the razor handle 20. However, the front side shape of the second end portion 292c may be varied depending on the structure, etc. of the connector 180, and may be configured without the inclined surface toward the positive X-axis direction.

When the second end portion 292c includes the stepped portion formed on the rear side thereof, which is approximately perpendicular to the second driving arm 292a, the second end portion 292c is prevented from being disengaged in the negative Y-axis direction while being inserted in the connecting hole 184, so that the razor cartridge 10 and the razor handle 20 are maintained in the coupled state. The rear side of the second end portion 292c may be modified to have various shapes so as not to form the stepped portion that is approximately perpendicular to the second driving arm 292a, and to prevent the second end portion 292c from being disengaged in the negative Y-axis direction while the second end portion 292c is inserted in the connecting hole 184.

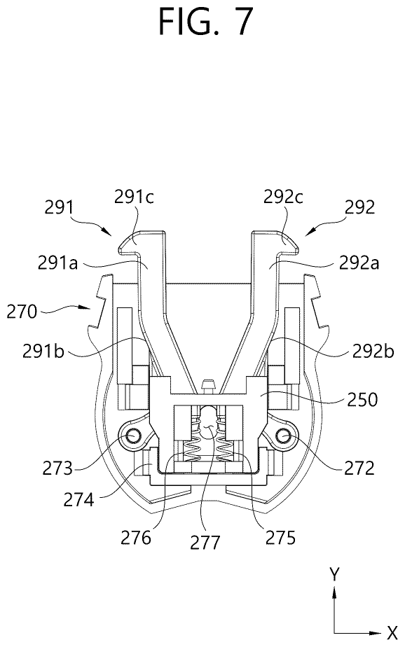

FIG. 7 is a view showing a position relationship among the first arm 291, the second arm 292, and the pusher 250 in a neutral state.

The neutral state in FIG. 7 refers to a state in which no other external force is applied to the pusher 250, the first arm 291 and the second arm 292. Therefore, in the neutral state, the pusher 250 may be located at or adjacent to the retreat limit point, and the first arm 291 and the second arm 292 may be spread outward as much as possible with respect to each other.

The detached state where the razor handle 20 and the razor cartridge 10 are completely detached and/or the coupled state where the razor handle 20 and the razor cartridge 10 are completely coupled may be the neutral state.

Meanwhile, even in the same neutral state, the position of the plunger 240 may be varied depending on whether it is in the detached state or the coupled state. For example, in the detached state, the plunger 240 may be positioned forward so that the first end portion 291c and the second end portion 292c can be covered with the plunger 240 (see FIG. 11), and in the coupled state, the position of the plunger 240 may retreat so that the first end portion 291c and the second end portion 292c can be exposed to the outside of the plunger 240.

On the other hand, the detached state and/or the coupled state may not be the neutral state. For example, when the first end portion 291c and the second end portion 292c in the detached state are supported on the first lateral wall 243 and the second lateral wall 242 of the plunger 240, respectively, a distance between the first end portion 291c and the second end portion 292c in the detached state may be shorter than a distance between the first end portion 291c and the second end portion 292c in the neutral state. Alternatively, in the coupled state, the first driving arm 291a, the first end portion 291c, the second driving arm 292a and/or the second end portion 292c may be supported on the connector 180, for example, on the guide surfaces 183, such that a distance between the first end portion 291c and the second end portion 292c in the coupled state may be shorter than the distance between the first end portion 291c and the second end portion 292c in the neutral state.

However, when the first end portion 291c and the second end portion 292c in the detached state are not supported by the first lateral wall 243 and the second lateral wall 242 of the plunger 240, respectively, but positioned adjacent to the first lateral wall 243 and the second lateral wall 242, the distance between the first end portion 291c and the second end portion 292c may be substantially the same in the detached state and the neutral state, or in the detached state, the neutral state and the coupled state.

Referring to FIG. 7, in the detached state and/or the coupled state, the pusher 250 may be positioned at the retreat limit point or adjacent to the retreat limit point in the first direction. In this case, the driving protrusion 253 of the pusher 250 may be positioned at the innermost point of the first driving surface 291b and the innermost point of the second driving surface 292b. Further, the pusher 250 may be supported on the support base 274.

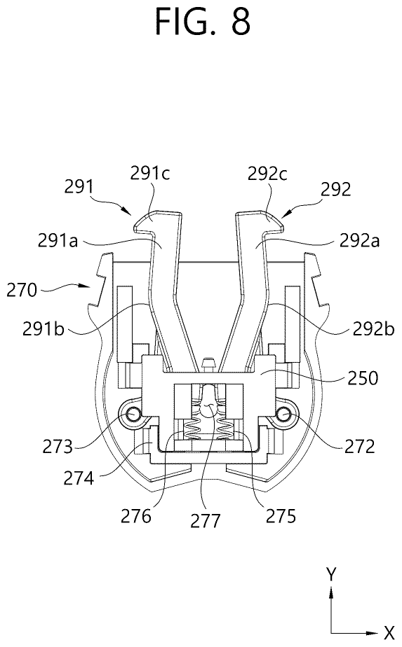

FIG. 8 is a view showing a position relationship among the first arm 291, the second arm 292 and the pusher 250 in a coupling process. In this specification, the coupling process refers to the process in which the razor handle 20 and the razor cartridge 10 are connected, in other words, an intermediate process from the detached state toward the coupled state.

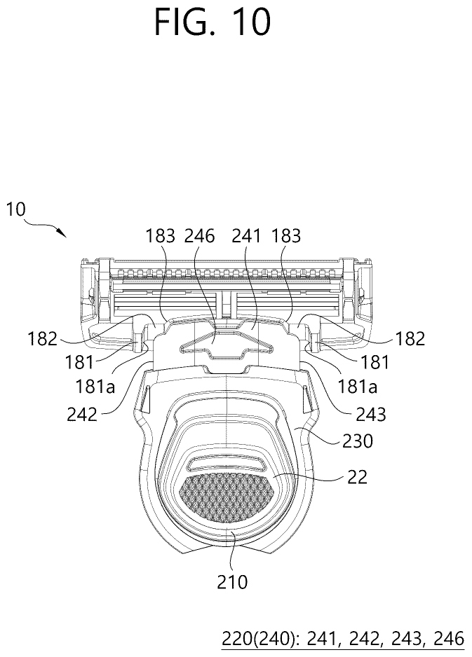

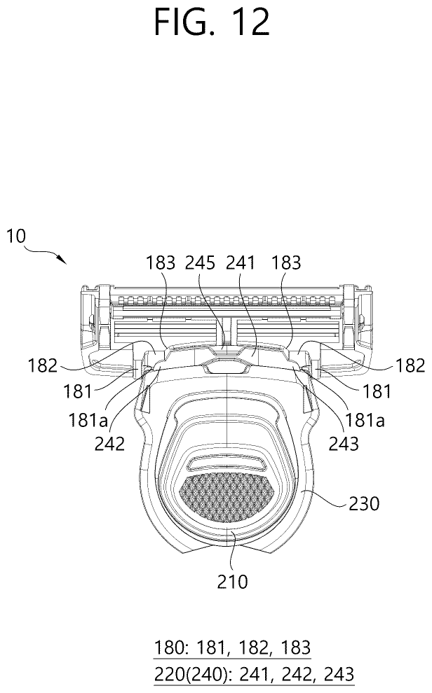

After a distal end portion 241a of the plunger 240 comes into contact with the blade housing 110 as the connector 180 of the razor cartridge 10 and the handle head 22 approach each other, the plunger 240 retreats rearwardly in the first direction toward the inside of the plunger housings 230 and 270 while being supported by the stepped portions 182 and/or the guide surfaces 183 (see FIGS. 10 and 12). The contact between the distal end portion 241a of the plunger 240 and the blade housing 110 may occur before the contact between the distal end portions 291d and 292d of the arms 291 and 292 and the connector 180. In this case, the contact between the distal end portions 291d and 292d of the arms 291 and 292 and the connector 180 may be made after the plunger 240 has retreated a predetermined distance rearwardly in the first direction.

Alternatively, the contact between the distal end portion 241a of the plunger 240 and the blade housing 110 may occur simultaneously with the contact between the distal end portions 291d and 292d of the arms 291 and 292 and the connector 180.

Alternatively, the contact between the distal end portions 291d and 292d of the arms 291 and 292 and the connector 180 may occur before the contact between the distal end portion 241a of the plunger 240 and the blade housing 110.

The lower surface 110b region of the blade housing 110 to be in contact with the plunger 240 may be formed to correspond to at least a portion of the shape of the distal end portion 241a of the plunger 240. In this way, the plunger 240 and the blade housing 110 may be in stable contact with each other, and the coupling positions of the connector 180 and the handle head 22 may be naturally aligned. Further, a user's recognition for the alignment direction of the connector 180 and the handle head 22 may be improved.

For example, the stepped portions 182 and/or the guide surface 183 of the connector 180 may be shaped to correspond to the shapes of both sides of the distal end portion 241a of the plunger 240 and the lateral walls 242 and 243 of the plunger 240. Alternatively, the distal end portion 241a of the plunger 240 may be formed convexly so as to make a longitudinal (X-directional) width become narrower in the first direction, and the lower surface 110b region of the blade housing 110 to be in contact with the distal end portion 241a may be formed concavely so as to be aligned with the distal end portion 241a.

As the connector 180 and the handle head 22 approach further each other, the first end portion 291c of the first arm 291 and the second end portion 292c of the second arm 292 pass along the guide surface 183 or pass the stepped portions 182 and the guide surfaces 183 in sequence, and, as shown in FIG. 8, the first arm 291 and the second arm 292 rotate about the first arm rotation pin 273 and the second arm rotation pin 272, respectively, such that the first end portion 291c and the second end portion 292c become closer. The elastic members 275 and 276 provide restoring forces to the first arm 291 and the second arm 292, respectively, in a direction of increasing the distance between the first end portion 291c and the second end portion 292c, so that the first end portion 291c and the second end portion 292c can move while maintaining the contact with the guide surface 183.

When each of the first end portion 291c and the second end portion 292c passes through the guide surface 183, the first end portion 291c and the second end portion 292c move back to the neutral state (the coupled state) illustrated in FIG. 7 while entering the connecting holes 184 by the restoring force provided from the elastic members 275 and 276.

Referring back to FIG. 8, in the process of coupling the razor cartridge 10 and the razor handle 20, the pusher 250 may not move from the neutral state. In other words, a user may complete the coupling between the razor cartridge 10 and the razor handle 20 even though s/he does not close the first arm 291 and the second arm 292 together by manipulating the operating portion 210 in the process of coupling the razor cartridge 10 and the razor handle 20.

The connector 180 includes the guide surface 183, thereby guiding the first end portion 291c of the first arm 291 and the second end portion 292c of the second arm 292 to naturally enter the connecting holes 184 by a user's simple motion of bringing the razor cartridge 10 and the razor handle 20 closer to each other.

Further, the handle head 22 includes the elastic members 275 and 276 that provide the restoring force to the first arm 291 and the second arm 292, thereby inducing the first end portion 291c and the second end portion 292c to naturally enter the connecting holes 184 immediately after passing the guide surface 183 by a user's simple motion of bring the razor cartridge 10 and the razor handle 20 closer to each other.

Further, even with a user's simple motion of bringing the razor cartridge 10 and the razor handle 20 closer to each other, the plunger 240 is supported on the blade housing 110 and retreats toward the inside of the plunger housings 230 and 270, and the first end portion 291c of the first arm 291 and the second end portion 292c of the second arm 292 are automatically exposed from the plunger 240 and coupled to the connector 180. In other words, the first end portion 291c of the first arm 291 and the second end portion 292c of the second arm 292 are covered with the plunger 240 in the detached state so as not to be exposed to the outside, but a user does not need to separately operate the plunger 240 so as to couple the razor cartridge 10 and the razor handle 20.

Accordingly, a user may complete the coupling of the razor cartridge 10 and the razor handle 20 by only bring the razor cartridge 10 and the razor handle 20 closer to each other without manipulating the operating portion 210 or the plunger 240 during the coupling process of the razor cartridge 10 and the razor handle 20.

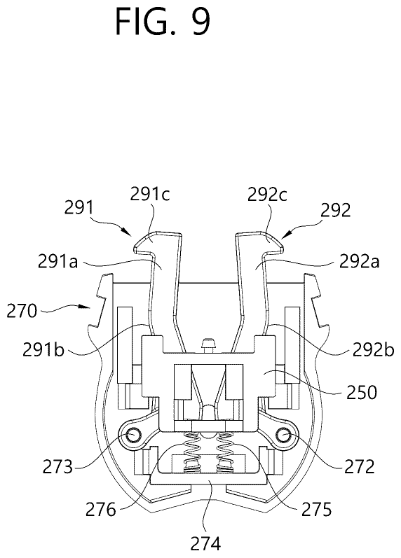

FIG. 9 is a view showing a position relationship among the first arm 291, the second arm 292 and the pusher 250 during the detachment process. In this specification, the detachment process refers to the process in which the razor handle 20 and the razor cartridge 10 are detached, in other words, an intermediate process from the coupled state to the detached state.

To detach the razor cartridge 10 and the razor handle 20, a user may move the operating portion 210 forward in the first direction, thereby causing the pusher 250 to move forward in the first direction.

Referring to FIG. 9, as the pusher 250 moves forward in the first direction, the driving protrusion 253 of the pusher 250 moves along the first driving surface 291b and the second driving surface 292b while moving forward in the first direction. As the driving protrusion 253 moves forward in the first direction, the first arm 291 rotates clockwise about the first arm rotation pin 273, and the second arm 292 rotates counterclockwise about the second arm rotation pin 272, thereby getting the first end portion 291c and the second end portion 292c closer to each other gradually.

Because the pusher 250 moves integrally with the operating portion 210, a user may make the operating portion 210 moves forward in the first direction to bring the first end portion 291c and the second end portion 292c closer to each other. When a user wants to detach the razor cartridge 10 and the razor handle 20, s/he may move the operating portion 210 forward in the first direction to bring the first end portion 291c and the second end portion 292c closer to each other, thereby detaching the first end portion 291c and the second end portion 292c from the connector 180 of the razor cartridge 10.

In the state of FIG. 9, when a user removes the force for moving the operating portion 210 forward in the first direction, the first arm 291 and the second arm 292 return back to the state of FIG. 7 by the restoring force of the elastic members 275 and 276. As the first arm 291 and the second arm 292 return back to the state of FIG. 7, the pusher 250 also retreats and becomes positioned in the state of FIG. 7 by the interaction between the driving protrusion 253 and the first and second driving surfaces 291b and 292b. Along with the retreat of the pusher 250, the operating portion 210 also retreats and becomes positioned at the retreat limit point.

FIG. 10 is a plan view showing a state immediately before the handle head 22 is coupled to the razor cartridge 10 according to an embodiment of the disclosure, and FIG. 11 is a bottom view showing the handle head 22 in the state of FIG. 10.

In FIGS. 10 and 11, the razor cartridge 10 and the handle head 22 are in the state just before being coupled to each other, and thus the plunger 240, the first arm 291 and the second arm 292 are assumed to be in the ‘detached state’ mentioned above with reference to FIG. 7.

Referring to FIGS. 10 and 11, in the state that the handle head 22 is detached from the razor cartridge 10, the first arm 291 and the second arm 292 exposed from the open distal end portion of the plunger housings 230 and 270 are not exposed to the outside by the plunger 240. Because the first arm 291 and the second arm 292 are not exposed to the outside, the first arm 291 and the second arm 292 are protected from external impact, thereby extending the lifespan of the razor handle 20 and improving aesthetics in an outer appearance.

Referring to FIG. 11, in the state that the handle head 22 is detached from the razor cartridge 10, the first arm 291 may be supported or in contact with the first lateral wall 243 of the plunger 240, and the second arm 292 may be supported or in contact with the second lateral wall 242 of the plunger 240. Alternatively, in the state that the handle head 22 is detached from the razor cartridge 10, the first arm 291 may be spaced apart from the first lateral wall 243 of the plunger 240, and the second arm 292 may be spaced apart from the second lateral wall 242 of the plunger 240.

Further, referring to FIG. 11, in the state that the handle head 22 is detached from the razor cartridge 10, the distal end portion 291d of the first arm 291 and the distal end portion 292d of the second arm 292 may be positioned reward than the distal end portion 241a of the plunger 240 in the first direction, such that the plunger 240 covers the first arm 291 and the second arm 292 from above. Alternatively, in the state that the handle head 22 is detached from the razor cartridge 10, the distal end portion 291d of the first arm 291 and the distal end portion 292d of the second arm 292 may be located at the same position as the distal end portion 241a of the plunger 240 in the first direction.

Further, in the process of coupling the handle head 22 and the razor cartridge 10, the contact between the distal end portion 241a of the plunger 240 and the blade housing 110 may occur before the contact between the distal end portions 291d and 292d of the arms 291 and 292 and the connector 180. When the contact between the distal end portion 241a of the plunger 240 and the blade housing 110 occurs, natural alignment may be induced at the coupling position between the razor cartridge 10 and the razor handle 20, and a user's recognition for the direction of aligning the razor cartridge 10 and the razor handle 20 may be improved. Further, referring to FIG. 11, in the state that the razor cartridge 10 is detached from the handle head 22, an outer distance D2 between the first end portion 291c and the second end portion 292c may be smaller than a longitudinal width D3 of the plunger 240 so that the plunger 240 can cover the first arm 291 and the second arm 292 from above. Alternatively, in the state that the razor cartridge 10 is detached from the handle head 22, the outer distance D2 between the first end portion 291c and the second end portion 292c may be substantially equal to the longitudinal width D3 of the plunger 240. As examples shown in FIGS. 10 and 11, the restoring force providing portion 220 includes the plunger 240, but the disclosure is not limited thereto. The restoring force providing portion 220 may include a cantilever structure and/or a rubber member providing an elastic force, etc., to provide the restoring force to the razor cartridge 10.

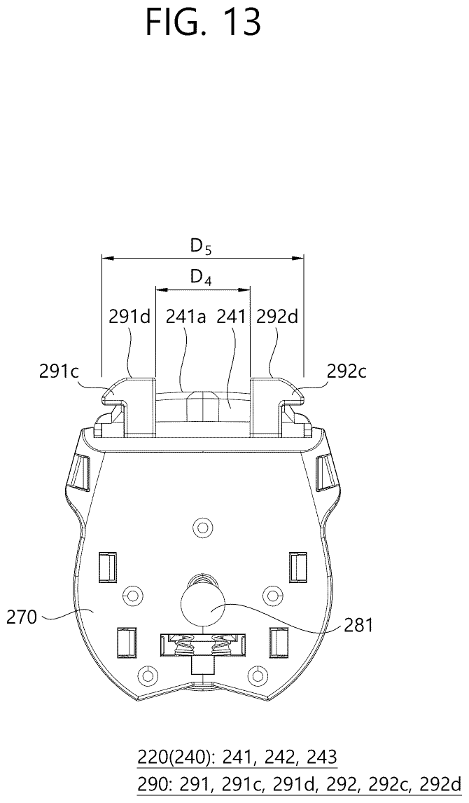

FIG. 12 is a plan view showing the state that the handle head 22 is coupled to the razor cartridge 10 according to an embodiment of the disclosure, FIG. 13 is a bottom view showing the handle head 22 in the state of FIG. 12, and FIG. 14 is a perspective view showing a portion of the razor assembly 1 from which the plunger 240 is omitted from the state of FIG. 12

Referring to FIG. 12, when the handle head 22 is coupled to the razor cartridge 10, the plunger 240 is positioned between the pair of guide posts 181. Further, the first lateral wall 243 and the second lateral wall 242 of the plunger 240 face the pair of the stepped portions 182, respectively. The first lateral wall 243 and the second lateral wall 242 may be positioned adjacent to the stepped portions 182, respectively, or may be supported on the stepped portions 182.

When the razor cartridge 10 is pivoted about the handle within its full pivot range, at least a portion of the pair of guide posts 181 may be positioned to correspond to the outer lateral surfaces of the handle head 22. Specifically, the inner supporting surfaces 181a of the pair of guide posts 181 may be positioned to correspond to the outer lateral surfaces of the plunger housings 230 and 270.

Meanwhile, the inner supporting surfaces 181a of the pair of guide posts 181 prevent the detachment between the razor cartridge 10 and the handle head 22 and/or the ejection of the razor cartridge 10 from the handle head 22 when an impact occurs in the razor assembly 1, such as when the razor assembly 1 is dropped, regardless of the degree of pivot of the razor cartridge 10.

Referring to FIGS. 12 to 14, the process of coupling the razor cartridge 10 and the razor handle 20 will be described. The plunger 240 is supported by the connector 180 and retreats toward the inside of the plunger housings 230 and 270. As the plunger 240 retreats, the first arm 291 and the second arm 292 are exposed, and the first end portion 291c and the second end portion 292c come into contact with the pair of guide surfaces 183 and 294, respectively. As the razor cartridge 10 and the razor handle 20 get closer, the first arm 291 and the second arm 292 rotate so that the distance between the first end portion 291c and the second end portion 292c can get closer until the first end portion 291c and the second end portion 292c pass the pair of guide surfaces 183. After the first end portion 291c and the second end portion 292c pass the pair of guide surfaces 183, the first arm 291 and the second arm 292 are rotated so that the first end portion 291c and the second end portion 292c can move away from each other by the restoring force provided from the elastic members 275 and 276, and as illustrated in FIG. 14, each of the first end portion 291c and the second end portion 292c enters the connecting holes 184 (see FIG. 4) between the guide surface 183 and the blade housing 110, thereby completing the coupling between the coupling portion 290 and the connector 180.

In the neutral state, when the first arm 291 and the second arm 292 are supported by or in contact with the first lateral wall 243 and the second lateral wall 242 of the plunger 240, the plunger 240 retreats in the process of coupling the coupling portion 290 and the connector 180, thereby releasing the support or contact state between the first arm 291 and the first lateral wall 243 and the support or contact state between the second arm 292 and the second lateral wall 242. The coupling between the coupling portion 290 and the connector 180 may be performed simultaneously with the release of the support or contact state between the first arm 291 and the first lateral wall 243 and the release of the support or contact state between the second arm 292 and the second lateral wall 242.

Meanwhile, in the neutral state, when the first arm 291 and the second arm 292 are not supported or in contact with the first lateral wall 243 and the second lateral wall 242 of the plunger 240, and the first end portion 291c and the second end portion 292c are spaced apart from the first lateral wall 243 and the second lateral wall 242, the contact between the plunger 240 and the blade housing 110 may occurs first with a time difference from or may occur simultaneously with the contact between the connector 180 and the first and second arms 291 and 292, depending on the relative positions between the distal end portion 241a of the plunger 240 and the first and second end portions 291c and 292c, the lower surface 110b shapes of the blade housing 110 to come into contact with the plunger 240, the shapes of the connector 180, etc. in the process of coupling the coupling portion 290 and the connector 180.

Because the plunger 240 is elastically supported by the elastic member 260 (see FIG. 5) disposed between the plunger 240 and the pusher 250, the plunger 240 maintains the contact with the razor cartridge 10 and provides the restoring force to the razor cartridge 10 while moving forward or backward along the first direction even though the razor cartridge 10 pivots being coupled to the razor handle 20.

Referring to FIG. 13, in the state that the handle head 22 is coupled to the razor cartridge 10, the distal end portion 291d of the first arm 291 and the distal end portion 292d of the second arm 292 may be positioned in front of the distal end portion 241a of the plunger 240 in the first direction.

Referring to FIG. 12, even when the coupling portion 290 is coupled to the connector 180, the first arm 291 and the second arm 292 exposed to the outside of the plunger housings 230 and 270 may be covered with the plunger 240 and not exposed to the outside. For example, when the razor cartridge 10 and the razor handle 20 are coupled, the first arm 291 and the second arm 292 may not be exposed to the outside by the plunger 240 in the state (resting position) that the razor cartridge 10 is supported by the plunger 240 without an external force applied thereto, but the first arm 291 and the second arm 292 may be at least partially not covered by the plunger 240 but exposed to the outside in the state that the razor cartridge 10 is pivoted from the resting state by an external force applied to the razor cartridge 10 and/or the razor handle 20.

At least in the resting position, in the state that the coupling portion 290 is coupled to the connector 180 so as not to be exposed to the outside by the plunger 240, an outer distance D5 between the first end portion 291c and the second end portion 292c may be smaller than or substantially equal to the longitudinal width D3 of the plunger 240.

Further, an inner distance D4 between the first end portion 291c and the second end portion 292c may be smaller than the longitudinal width D3 of the plunger 240, but the disclosure is not limited thereto. According to an embodiment, the inner distance D4 between the first end portion 291c and the second end portion 292c may be substantially equal to the longitudinal width D3 of the plunger 240. In this case, when the coupling portion 290 is coupled to the connector 180, the first arm 291 and the second arm 292 exposed to the outside of the plunger housings 230 and 270 may not be exposed to the outside as covered not only with the plunger 240 but also with a certain region of the connector 180 located at the longitudinal lateral side of the plunger 240.

For example, in the state that the coupling portion 290 is coupled to the connector 180, a ratio of the longitudinal width D3 of the plunger 240 to an outer distance D5 between the first end portion 291c and the second end portion 292c may range from 0.8 to 1.2.

Meanwhile, the inner distance D4 and the outer distance D5 between the first end portion 291c and the second end portion 292c in the state that the coupling portion 290 is coupled to the connector 180 may be substantially the same as the inner distance D1 (see FIG. 11) and the outer distance D2 between the first end portion 291c and the second end portion 292c in the state that the coupling portion 290 is detached from the connector 180.

Alternatively, the inner distance D4 and the outer distance D5 between the first end portion 291c and the second end portion 292c in the state that the coupling portion 290 is coupled to the connector 180 may be smaller than the inner distance D1 (see FIG. 11) and the outer distance D2 between the first end portion 291c and the second end portion 292c in the state that the coupling portion 290 is detached from the connector 180.

As examples shown in FIGS. 12 and 13, the restoring force providing portion 220 includes the plunger 240, but the disclosure is not limited thereto. Alternatively, the restoring force providing portion 220 may include a cantilever structure and/or a rubber member providing an elastic force, etc. to provide the restoring force to the razor cartridge 10.

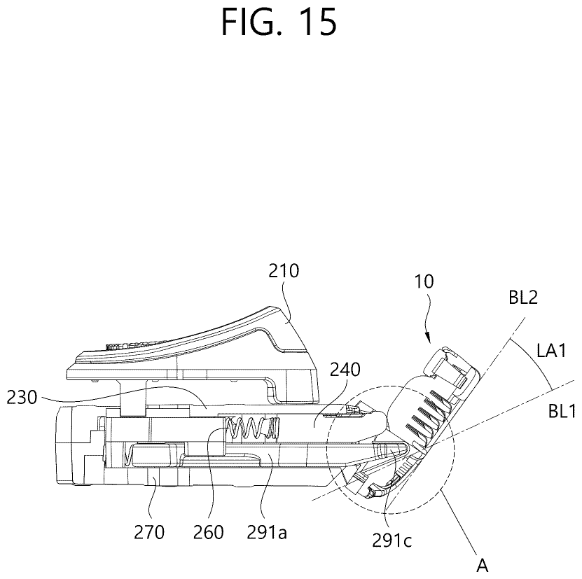

FIG. 15 is a cross-sectional view illustrating a state in which the pivot angle of the razor cartridge 10 according to an embodiment of the disclosure is restricted by the first end portion 291c, the second end portion 292c, and the inner wall 186 of the connecting hole 184. Specifically, FIG. 15 illustrates the maximum pivoted state of the razor cartridge 10.

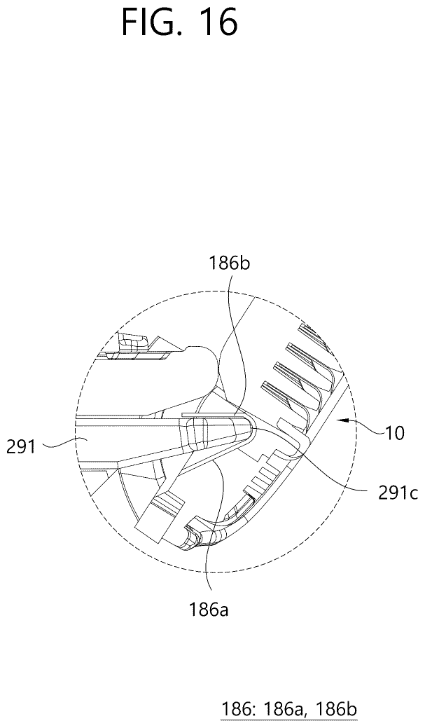

FIG. 16 is an enlarged view of an area A shown in FIG. 15.

Referring to FIG. 14 to FIG. 16, the first end portion 291c of the first arm 291 may be supported on the inner wall 186 of the connecting hole 184. Referring to FIG. 16, the inner wall 186 of the connecting hole 184 includes a first inner wall 186a and a second inner wall 186b which face each other, and the first end portion 291c is in contact with at least one of the first inner wall 186a and the second inner wall 186b when the razor cartridge 10 is in a rest state or in the maximum pivoted state. The first inner wall 186a may correspond to a surface extended from the connecting groove 185, and the second inner wall 186b may be a surface facing the first inner wall 186a.

In detail, one surface of the first end portion 291c of the first arm 291 is in contact with the first inner wall 186a when the razor cartridge 10 is in the rest state. On the other hand, the other surface of the first end portion 291c of the first arm 291 is in contact with the second inner wall 186b when the razor cartridge 10 is released from the rest state and reaches the maximum pivoted state.

In more detail, the razor cartridge 10 may be pivoted until the first end portion 291c is in contact with and supported on the second inner wall 186b, and then the pivot thereof may be restricted. The pivot angle control of the razor cartridge 10 is varied depending on distances between the first inner wall 186a and the second inner wall 186b. The pivot angle of the razor cartridge 10, the pivot of which is first limited is referred to as a primary maximum pivot angle LA1. The second end portion 292c of the second arm 292 having the same function and structure as the first end portion 291c may be restricted to pivot the razor cartridge 10 up to the primary maximum pivot angle LA1 together with the first end portion 291c.

Referring to FIG. 15, the primary maximum pivot angle LA1 may be defined using a line passing through the shaving plane formed by the guard 140 and the cap 150 as a reference line. The primary maximum pivot angle LA1 may be an angle formed between a reference line BL1 of when the razor cartridge 10 is in the rest position and a reference line BL2 of when the razor cartridge 10 is in a state where its pivot angle is restricted by the first end portion 291c and the second end portion 292c.

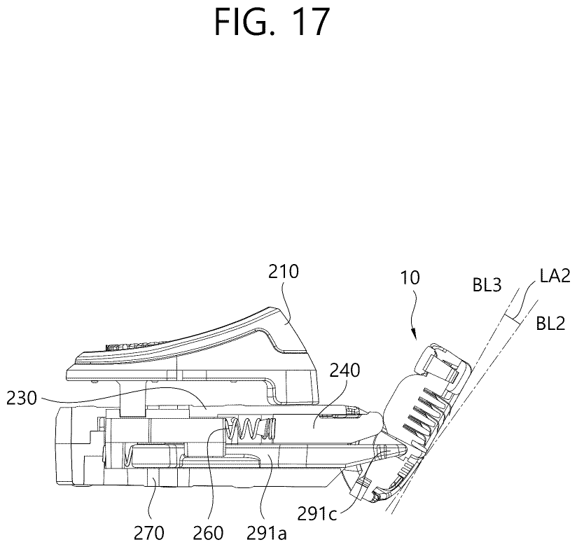

Referring to FIG. 17, a secondary maximum pivot angle LA2 may be restricted by the inner wall 186 of the connecting hole 184, but may also be restricted by the plunger 240. The pivot angle of the razor cartridge 10, which is additionally restricted after the primary maximum pivot angle LA1, is referred to as the secondary maximum pivot angle LA2.

The secondary maximum pivot angle LA2 may be an angle formed between the reference line BL2 of when the razor cartridge 10 is pivoted by the primary maximum pivot angle and a reference line BL3 of when the razor cartridge 10 is in a state where its pivot angle is restricted by the plunger 240. The razor cartridge 10 pivoted up to the secondary maximum angle LA2 may be pivoted overall by an angle that is the sum of the primary maximum pivot angle LA1 and the secondary maximum pivot angle LA2.

When a larger external force is applied to the razor cartridge 10 in the state that the razor cartridge 10 is pivoted to the primary maximum pivot angle LA1, the components of the razor cartridge 10 and the handle head 22 may be additionally pivoted due to minute spaces between the component, elastic deformation of the components, etc. This deformation may cause the razor cartridge 10 to pivot beyond the primary maximum pivot angle LA1.

In this case, the plunger 240 may reach the maximum retreat position after retreating by a distance corresponding to the secondary maximum pivot angle LA2. The maximum retreat position of the plunger 240 may be determined in such a way that a stopper formed in the plunger 240 is caught on a protrusion formed inside the plunger housings 230 and 270. However, the disclosure is not limited thereto, and the maximum retreat position of the plunger 240 may be determined in another way. The razor cartridge 10 may be pivoted until the razor cartridge 10 is supported by the plunger 240 as the plunger 240 reaches the maximum retreat position, and may not be pivoted after being supported. The razor cartridge 10 may be pivoted up to the secondary maximum pivot angle LA2 by the plunger 240.

Meanwhile, when the razor cartridge 10 pivots beyond the primary maximum pivot angle LA1, the plunger 240 may be retreated further back (in the negative Y-axis direction of FIG. 8) without blocking further pivoting of the razor cartridge 10. That is, in order to prevent damage to the cam 112 of the razor cartridge 10 by the plunger 240, the plunger 240 may be retreated further by a predetermined distance.

Further, when the razor cartridge 10 pivots beyond the primary maximum pivot angle LA1, both lateral end portions of the plunger 240 may come into contact with the ribs formed on the lower surface 110b of the blade housing 110, thereby alleviating the impact applied to the razor cartridge 10, for example, the cam 112.

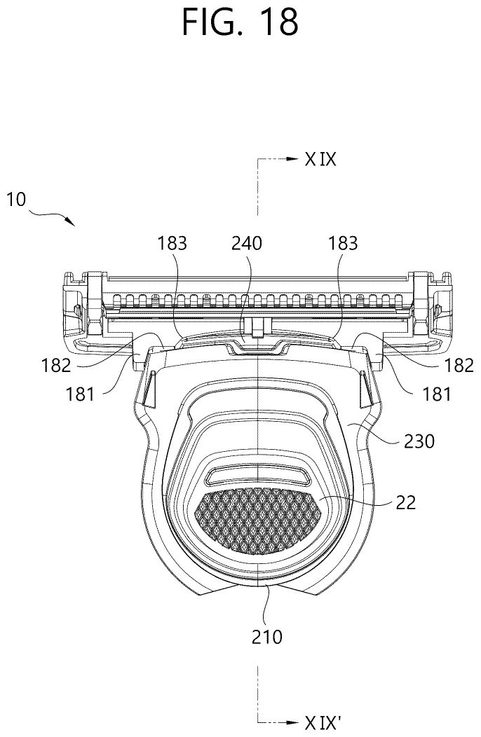

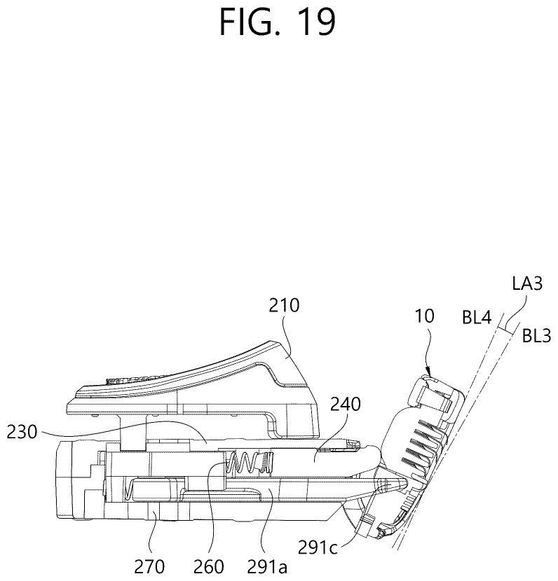

FIG. 18 is a bottom view showing a state in which the pivot angle of the razor cartridge 10 according to an embodiment of the disclosure is restricted by the stepped portion 182, and FIG. 19 is a cross-sectional view taken along line X IX-X IX′ of FIG. 18.

Referring to FIG. 17 and FIG. 18, when the razor cartridge 10 pivots beyond the secondary maximum pivot angle LA2, the stepped portion 182 may support the handle head 22. Specifically, the stepped portion 182 may support the open distal end portion of the plunger housings 230 and 270.

When a larger external force is applied to the razor cartridge 10 in the state that the razor cartridge 10 is pivoted to the secondary maximum pivot angle LA2, the components of the razor cartridge 10 and the handle head 22 may additionally pivot due to the micro spaces between the components, elastic deformation of the components, etc. This deformation may cause the razor cartridge 10 to additionally pivot beyond the secondary maximum pivot angle LA2.

In the state that the razor cartridge 10 is pivoted less than the secondary maximum pivot angle LA2, the stepped portion 182 and the open distal end portion of the plunger housings 230 and 270 are spaced apart from each other and are not in contact with each other. However, referring to FIG. 18, when the razor cartridge 10 is pivoted beyond the secondary maximum pivot angle LA2, the stepped portion 182 and the plunger housings 230 and 270 may come closer to each other and be in contact with each other.

Referring to FIGS. 18 and 19, the razor cartridge 10 may be pivoted until the open distal end portion of the plunger housings 230 and 270 is supported by the stepped portion 182, and may not be pivoted after being supported. The pivot angle of the razor cartridge 10 may be restricted by the stepped portion 182. The pivot angle of the razor cartridge 10, which is additionally limited after the secondary maximum pivot angle LA2, is referred to as a tertiary maximum pivot angle LA3.

The tertiary maximum pivot angle LA3 may be an angle formed between a reference line BL3 of when the razor cartridge 10 is pivoted by the secondary maximum pivot angle and a reference line BL4 of when the pivot angle of the razor cartridge 10 is restricted by the stepped portion 182. The razor cartridge 10 pivoted up to the tertiary maximum pivot angle LA3 may be pivoted overall by an angle that is the sum of the primary maximum pivot angle LA1, the secondary maximum pivot angle LA2, and the tertiary maximum pivot angle LA3.

In another embodiment of the disclosure, the primary maximum pivot angle LA1 may be limited either by the razor cartridge 10 and the plunger 240 being in a maximum retreated position or by the stepped portion 182 and the handle head 22. The secondary maximum pivot angle LA2 may be limited either by the first end portion 291c, the second end portion 292c and the inner wall 186 of the connecting hole 184 or by the stepped portion 182 and the handle head 22. The tertiary maximum pivot angle LA3 may be limited either by the first end portion 291c, the second end portion 292c and the inner wall 186 of the connecting hole 184 or by the razor cartridge 10 and the plunger 240 at the maximum retracted position.

For example, when the razor cartridge 10 pivots beyond the primary maximum pivot angle LA1, the razor cartridge 10 may be pivoted by either the stepped portion 182 or the plunger 240 to the secondary maximum pivot angle LA2, and may be pivoted by the other to the tertiary maximum pivot angle LA3 exceeding the secondary maximum pivot angle LA2.

As another example, the razor cartridge 10 may be pivoted to the primary maximum pivot angle LA1 by the plunger 240. In this case, the razor cartridge 10 may be pivoted to the secondary maximum pivot angle LA2 by the first end portion 291c and the second end portion 292c, and may be pivoted to the tertiary maximum pivot angle LA3 by the stepped portion 182. An impact applied to the coupling area between the razor cartridge 10 and the razor handle 20 may be alleviated. The impact applied to the coupling area between the razor cartridge 10 and the razor handle 20 may be alleviated by the plunger 240, the first end portion 291c, the second end portion 292c, and the stepped portion 182. In particular, when an impact is applied to the razor assembly 1, load applied to the coupling area between the connector 180 and the connecting portion 290 may be reduced due to impact distribution, thereby preventing detachment between the razor cartridge 10 and the razor handle 20.

Referring to FIG. 15, an impact applied to the razor cartridge 10 may cause the plunger 240 to retreat. As the plunger 240 retreats, an elastic member 260 that elastically supports the plunger 240 may be compressed. Some of the impact applied to the razor cartridge 10 may be converted into elastic energy of the compressed elastic member 260 and thus alleviated.

Referring to FIG. 19, the impact applied to the razor cartridge 10 may cause the plunger 240 to support the razor cartridge 10 at the maximum retreated position. The impact applied to the razor cartridge 10 may be converted into the elastic energy of the maximum compressed elastic member 260 and thus alleviated.

Referring to FIG. 15, an impact applied to the razor cartridge 10 may cause the first end portion 291c and the second end portion 292c to come into contact with the inner wall 186 of the connecting hole 184. The first end portion 291c and the second end portion 292c may be supported being in surface-contact with the inner wall 186 of the connecting hole 184. The impact applied to the razor cartridge 10 may be converted into energy for causing the inner wall 186 to be in contact with and support the first end portion 291c and the second end portion 292c, and thus load applied to the coupling area between the razor cartridge 10 and the razor handle 20 may be alleviated.

Meanwhile, the foregoing embodiment shows an example that the plunger 240 reaches the maximum retreated position and supports the razor cartridge 10, but the disclosure is not limited thereto. For example, the plunger 240 may be designed to continue to retreat without reaching the maximum retreated position even though the razor cartridge 10 is pivoted up to the primary, secondary or tertiary maximum pivot angle. In this case, the cam 112 is prevented from being damaged or deformed due to the impact generated from the plunger 240 and transmitted to the cam 112.

Referring to FIGS. 17 and 18, an impact applied to the razor cartridge 10 may cause the razor cartridge 10 to pivot beyond the primary maximum pivot angle LA1. In this case, the stepped portion 182 may come into contact with and support a front-end portion of the plunger housings 230 and 270.

In another embodiment of the disclosure, the impact applied to the razor cartridge 10 may be relieved sequentially or simultaneously. For example, the impact applied to the razor cartridge 10 may be primarily relieved through the compressive elastic force of the elastic member 260 based on the retreat of the plunger 240, secondarily relieved as the first end portion 291c and the second end portion 292c are supported on the inner wall 186 of the connecting hole 184, tertiarily relieved as the plunger 240 supports the razor cartridge 10 at the maximum retreated position, and quaternarily relieved as the stepped portion 182 supports the open distal end portion of the plunger housings 230 and 270.

The sequence of relieving the impact may be changed. For example, the impact applied to the razor cartridge 10 may be primarily relieved through the compression elastic force of the elastic member 260 based on the retreat of the plunger 240, secondarily relieved as the plunger 240 supports the razor cartridge 10 at the maximum retreated position, tertiarily relieved as the first end portion 291c and the second end portion 292c are supported on the inner wall 186 of the connecting hole 184, and quaternarily relieved as the stepped portion 182 supports the open distal end portion of the plunger housings 230 and 270. Some of the primary to quaternary relief means for controlling the pivot of the razor cartridge 10 may be omitted. For example, only the primary, secondary and tertiary relief means may be provided, or only the primary and secondary relief means may be provided, or only the primary relief means may be provided. Further, the foregoing exemplary sequence of the relief means may be changed. For example, the configuration in which the plunger 240 supports the razor cartridge 10 in the maximum retreated position may be located first, last or in a sequence therebetween in the overall sequence. Likewise, another relief means may be located first, last or in a sequence therebetween.

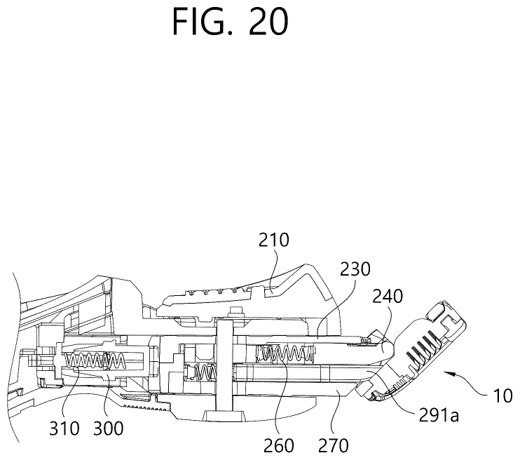

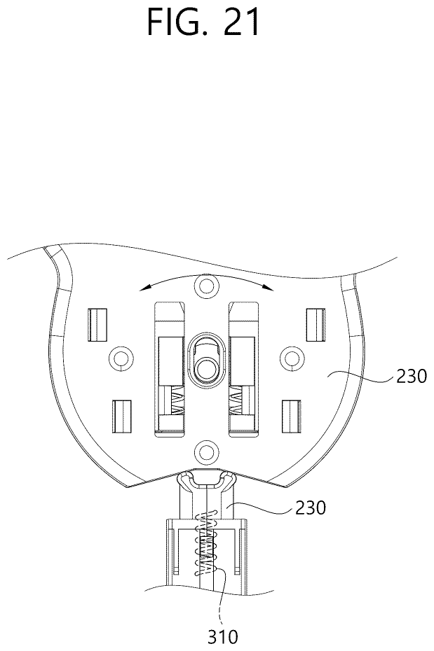

FIG. 20 is a view illustrating a state that a plunger housing according to an embodiment of the disclosure is supported by a head supporting portion 300, and FIG. 21 is a bottom view illustrating a state that the plunger housings 230 and 270 rotating clockwise or counterclockwise is supported by the head supporting portion 300 of FIG. 20.

Referring to FIGS. 20 and 21, the handle head 22 may further include the head supporting portion 300. The head supporting portion 300 may be in contact with the rear surface of the plunger housings 230 and 270 and may elastically support the plunger housings 230 and 270. The head supporting portion 300 may be supported by an elastic member 310, thereby elastically supporting the plunger housings 230 and 270. The plunger housings 230 and 270 may be retreated or rotated clockwise or counterclockwise about a rotation axis perpendicular to the longitudinal direction and the first direction.

Referring to FIG. 20, when the plunger housings 230 and 270 are retreated as the razor cartridge 10 pivots, the head supporting portion 300 may provide a restoring force to restore the plunger housings 230 and 270 to their previous position before they were retreated. The impact applied to the razor cartridge 10 may be primarily relieved by the compressive elasticity of the elastic member 260 as the plunger 240 retreats, secondarily relieved as the plunger 240 supports the razor cartridge 10 at the maximum retreated position, tertiarily relieved as the first end portion 291c and the second end portion 292c are supported on the inner wall 186 of the connecting hole 184, and quaternarily relieved as the stepped portion 182 supports the open distal end portion of the plunger housings 230 and 270.

Referring to FIG. 21, when the plunger housings 230 and 270 rotates clockwise or counterclockwise, the head supporting portion 300 may provide a restoring force to restore the plunger housings 230 and 270 to their previous position before they were rotated clockwise or counterclockwise. The impact applied to the razor cartridge 10 may be primarily relieved by the compressive elasticity of the elastic member 260 as the plunger 240 retreats, secondarily relieved as the plunger 240 supports the razor cartridge 10 at the maximum retreated position, tertiarily relieved as the first end portion 291c and the second end portion 292c are supported on the inner wall 186 of the connecting hole 184, and quaternarily relieved as the stepped portion 182 supports the open distal end portion of the plunger housings 230 and 270.

Referring to FIG. 18, the inner supporting surface 181a of the guide post 181 supports the outer lateral surface of the plunger housings 230 and 270, thereby maintaining a gap between the first end portion 291c and the second end portion 292c not to detach the first end portion 291c and the second end portion 292c from the connecting hole 184. Accordingly, the inner supporting surface 181a supports the outer lateral surface of the plunger housings 230 and 270, thereby preventing the razor cartridge 10 and the razor handle 20 from being detached.

Although an excessive external force or impact force is applied to the razor cartridge 10, the coupling state between the razor handle 20 and the razor cartridge 10 is maintained.

A person having ordinary knowledge in the art to which the disclosure pertains will appreciate that the disclosure may be implemented in other specific forms without changing the technical spirit or essential features thereof. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor assembly comprising a razor cartridge provided with a connector, and a razor handle detachably coupled to the connector and pivotably supporting the razor cartridge,
the razor handle comprising:
a first arm and a second arm spaced apart from each other in a longitudinal direction, the first and second arms coupled to the connector by moving away from each other, and detached from the connector by moving closer to each other; and
a handle head configured to receive at least a portion of the first arm and the second arm, and
the razor cartridge comprising a pair of guide posts having inner supporting surfaces formed to face outer lateral surfaces of the handle head while the razor cartridge and the razor handle are coupled.

2. The razor assembly of claim 1, wherein at least a portion of the pair of guide posts is positioned to correspond to the outer lateral surfaces of the handle head within a full pivot range thereof.

3. The razor assembly of claim 1, wherein the handle head comprises:
a plunger configured to slide in conjunction with pivot of the razor cartridge and to provide a restoring force to the razor cartridge; and
a plunger housing configured to guide the sliding of the plunger and to receive at least a portion of the plunger, and
wherein the inner supporting surfaces of the pair of guide posts are positioned corresponding to the outer lateral surfaces of the plunger housing.

4. The razor assembly of claim 3, wherein the plunger retreats in a direction toward the plunger housing with respect to a distal end portion of the plunger as the razor cartridge pivots from a rest position, and supports the razor cartridge at a maximum retreated position to restrict the pivot of the razor cartridge.

5. The razor assembly of claim 1, wherein the connector further comprises a pair of stepped portions extending from the pair of guide posts to face the handle head.

6. The razor assembly of claim 5, wherein the pair of stepped portions are supported on the handle head to restrict the pivot of the razor cartridge when the razor cartridge is positioned at a maximum pivot angle or pivots beyond the maximum pivot angle.

7. The razor assembly of claim 5, wherein the pair of guide posts are formed to protrude from the pair of stepped portions toward the outer lateral surfaces of the handle head.

8. The razor assembly of claim 5, wherein the connector comprises:
a connecting groove formed between the pair of stepped portions and allowing end portions of the first and second arms to enter thereinto; and
a connecting hole extending from the connecting groove toward an inner side of the pair of stepped portions and receiving end portions of the first arm and the second arm therein.

9. The razor assembly of claim 8, wherein the end portions of the first and second arms are supported on an inner wall of the connecting hole to restrict the maximum pivot angle of the razor cartridge.

10. The razor assembly of claim 8, wherein:
the razor cartridge has a primary maximum pivot angle determined as the end portions of the first and second arms are supported on an inner wall of the connecting hole, and
the razor cartridge has a secondary maximum pivot angle exceeding the primary maximum pivot angle and determined as the pair of stepped portions supports the handle head.

11. The razor assembly of claim 8, wherein:
the handle head comprises a plunger configured to slide in conjunction with pivot of the razor cartridge and provide a restoring force to the razor cartridge,
the razor cartridge has a primary maximum pivot angle determined as the end portions of the first and second arms are supported on an inner wall of the connecting hole, and
the razor cartridge has a secondary maximum pivot angle exceeding the primary maximum pivot angle and determined as the plunger supports the razor cartridge at a maximum retreated position.

12. The razor assembly of claim 11, wherein the razor cartridge has a tertiary maximum pivot angle exceeding the secondary maximum pivot angle and determined as the pair of stepped portions supports the handle head.

13. The razor assembly of claim 8, wherein:
the handle head comprises a plunger configured to slide in conjunction with pivot of the razor cartridge and provides a restoring force to the razor cartridge, and
an impact applied to the razor cartridge is:
primarily relieved as the plunger elastically supporting the razor cartridge retreats;
secondarily relieved as the end portions of the first and second arms are supported on an inner wall of the connecting hole forming the connecting hole;
tertiarily relieved as the plunger supports the razor cartridge at a maximum retreated position; and
quaternarily relieved as the pair of stepped portions supports the handle head.

14. The razor assembly of claim 8, wherein:
the handle head comprises a plunger configured to slide in conjunction with pivot of the razor cartridge and provides a restoring force to the razor cartridge,
the razor cartridge has a primary maximum pivot angle determined as the plunger supports the razor cartridge at a maximum retreated position, and
the razor cartridge has a secondary maximum pivot angle exceeding the primary maximum pivot angle and determined as the end portions of the first arm and the second arm are supported on an inner wall of the connecting hole.

15. The razor assembly of claim 14, wherein the razor cartridge has a tertiary maximum pivot angle exceeding the secondary maximum pivot angle and determined as the pair of stepped portions supports the handle head.

16. The razor assembly of claim 8, wherein:
the handle head comprises a plunger configured to slide in conjunction with pivot of the razor cartridge and provides a restoring force to the razor cartridge, and
an impact applied to the razor cartridge is:
primarily relieved as the plunger elastically supporting the razor cartridge retreats;
secondarily relieved as the plunger supports the razor cartridge at a maximum retreated position;
tertiarily relieved as the end portions of the first and second arms are supported on an inner wall of the connecting hole forming the connecting hole; and
quaternarily relieved as the pair of stepped portions supports the handle head.

17. The razor assembly of claim 8, wherein:
the razor cartridge comprises:
at least one blade formed with a cutting edge; and
a blade housing receiving the blade therein in a longitudinal direction and provided with the connector at one side thereof,
the blade housing comprises an upper surface exposing the cutting edge, a lower surface facing the upper surface, and a rinsing opening formed penetrating the blade housing from the upper surface to the lower surface and allowing the blade to be longitudinally arranged thereacross, and
the pair of guide posts and the pair of stepped portions are provided not to overlap the rinsing opening.
